(19) United States
(12) Patent Application Publication
(10) Pub. No.: US 2015/0294442 A1
(43) Pub. Date: Oct. 15, 2015

(54) CAMERA SYSTEM AND IMAGING METHOD

(71) Applicant: Kabushiki Kaisha Toshiba, Minato-ku (JP)

(72) Inventors: Takayuki OGASAHARA, Yokohama (JP); Yosuke BANDO, Yokohama (JP)

(73) Assignee: Kabushiki Kaisha Toshiba, Minato-ku (JP)

(21) Appl. No.: 14/636,369

(22) Filed: Mar. 3, 2015

(30) Foreign Application Priority Data
Apr. 15, 2014 (JP) 2014-083878

(51) Int. Cl. G06T 5/00; H04N 5/235; H04N 5/232

(52) U.S. Cl. CPC G06T 5/001; H04N 5/23212; H04N 5/2354

(57) ABSTRACT

According to one embodiment, a camera system comprises a light amount adjusting unit and a focus adjusting unit. The light amount adjusting unit adjusts a light-amount distribution of light having entered the image pickup optical system. The focus adjusting unit moves the image pickup lens between a first position and a second position to change focus continuously during the exposure time of the image sensor. The first position is located on the object side of the position of the image pickup lens when in focus. The second position is located on the image sensor side of the position of the image pickup lens when in focus.

### CROSS-REFERENCE TO RELATED APPLICATIONS

This application is based upon and claims the benefit of priority from Japanese Patent Application No. 2014-083878, filed on Apr. 15, 2014; the entire contents of which are incorporated herein by reference.

### FIELD

Embodiments described herein relate generally to a camera system and imaging method.

### BACKGROUND

Camera systems are required to be highly sensitive and be able to acquire sharp images. The camera system manages to get a larger amount of light so as to improve sensitivity. The camera system may manage to get a larger amount of light by lengthening the exposure time. As the exposure time becomes longer, a motion blur is more likely to occur. The motion blur refers to a blur caused by the motion of an object or a camera system. The camera system may also manage to get a larger amount of light by incorporating a lens of a low F-number as an image pickup optical system. If a lens of a low F-number is used, the depth of field of the camera system becomes shallow. In this case, because enough focus adjustment is difficult, an out-of-focus blur is likely to occur. The out-of-focus blur refers to a blur caused by being out of focus.

An image restoration process using a spatial filter is known as one of techniques for restoring a degraded image that is a blurred actual object image to being close to the original object image. The spatial filter is obtained by inferring a degradation model for the blur occurring in the degraded image. For an image including both a motion blur and an out-of-focus blur, it is difficult to infer a degradation model including these blurs. In this case, even if the image restoration process is performed, with the blur not being sufficiently cleared, a sharp image may not be obtained. Even if the sense of resolution is improved by performing the image restoration process, noise may be emphasized. Noise being emphasized results in a decrease in the quality of the image.

### BRIEF DESCRIPTION OF THE DRAWINGS

FIG. 1 is a block diagram showing schematically the configuration of a camera system according to a first embodiment;

FIG. 2 is a schematic diagram showing the configuration of an optical system incorporated in the camera system shown in FIG. 1;

FIG. 3 is a block diagram showing schematically the configuration of a camera system according to a second embodiment; and

FIG. 4 is a schematic diagram showing the configuration of an optical system incorporated in the camera system shown in FIG. 3.

### DETAILED DESCRIPTION

In general, according to one embodiment, a camera system comprises an image pickup optical system, a light amount adjusting unit, an image sensor, a focus adjusting unit, and an image restoring circuit. The image pickup optical system takes in light from an object. The light amount adjusting unit adjusts a light-amount distribution of light having entered the image pickup optical system. The image sensor picks up an object image. The focus adjusting unit adjusts focus of the image pickup optical system. The image restoring circuit performs an image restoration process on the image acquired by the image sensor. The image pickup optical system includes an image pickup lens. The image pickup lens moves according to control of the focus adjusting unit. The focus adjusting unit moves the image pickup lens between a first position and a second position to change focus continuously during the exposure time of the image sensor. The first position is located on the object side of the position of the image pickup lens when in focus. The second position is located on the image sensor side of the position of the image pickup lens when in focus.

The camera systems and imaging methods according to embodiments will be described in detail below with reference to the accompanying drawings. The present invention is not limited to these embodiments.

### First Embodiment

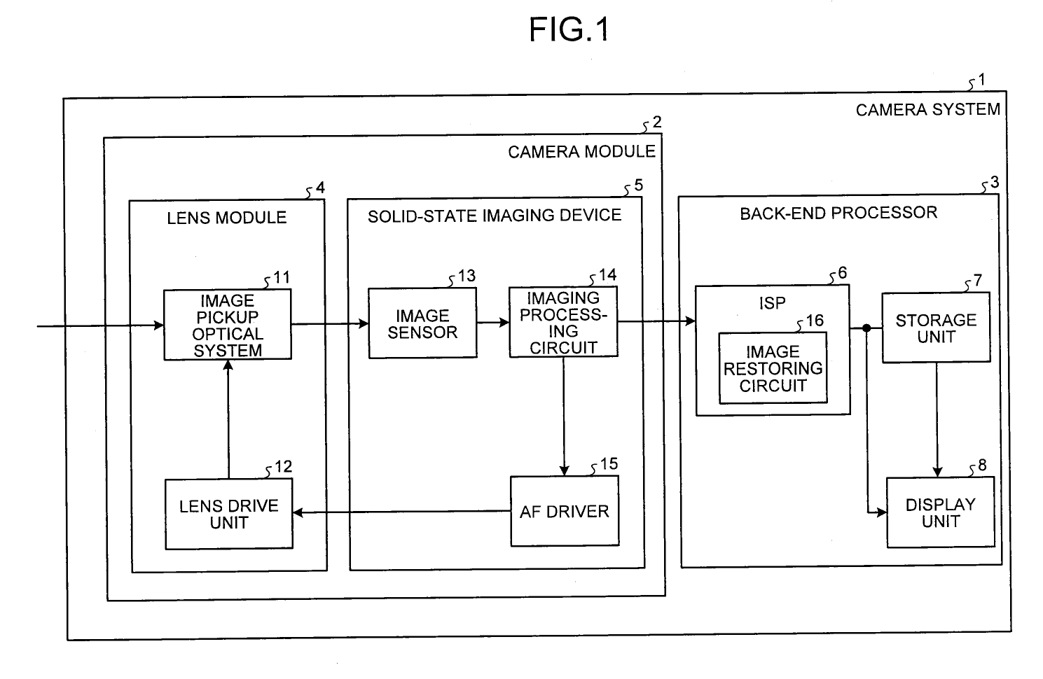

FIG. 1 is a block diagram showing schematically the configuration of a camera system according to the first embodiment. The camera system 1 is, for example, a digital camera. The camera system 1 may be either of a digital still camera and a digital video camera. The camera system 1 may be an electronic device comprising a camera module 2 such as a mobile terminal with a camera.

The camera system 1 has a camera module 2 and a back-end processor 3. The camera module 2 comprises a lens module 4 and a solid-state imaging device 5. The lens module 4 comprises an image pickup optical system 11 and a lens drive unit 12.

The image pickup optical system 11 takes in light from an object. The image pickup optical system 11 forms an object image. The lens drive unit 12 drives at least any of the lenses forming the image pickup optical system 11. The lens drive unit 12 moves the lens along the optical axis direction of the image pickup optical system 11.

The solid-state imaging device 5 has an image sensor 13, an imaging processing circuit 14, and an autofocus (AF) driver 15. The image sensor 13 picks up an object image. The image sensor 13 is, for example, a CMOS image sensor. The image sensor 13 may be a CCD instead of the CMOS image sensor.

The imaging processing circuit 14 executes various signal processes on the image signal from the image sensor 13. The imaging processing circuit 14 executes, as the various signal processes, defect correction, gamma correction, a noise reducing process, lens shading correction, white balance adjustment, distortion correction, resolution restoration, and the like.

The AF driver 15 that is a focus adjusting unit controls the lens drive unit 12 according to a control signal from the imaging processing circuit 14. The AF driver 15 controls the lens drive unit 12, thereby adjusting the focus of the image pickup optical system 11.

The back-end processor 3 has an image signal processor (ISP) 6, a storage unit 7, and a display unit 8. The ISP 6 comprises an image restoring circuit 16 that is an image restoring unit. The image restoring circuit 16 performs an image restoration, process on images acquired by the image sensor 13. The ISP 6 executes various processes such as a de-mosaic process as well as the image restoration process by the image restoring circuit 16.

The storage unit 7 stores images having undergone signal processing by the ISP 6 therein. The storage unit 7 outputs an image signal to the display unit 8 according to a user's operation or the like. The display unit 8 displays an image according to the image signal inputted from the ISP 6 or the storage unit 7. The display unit 8 is, for example, a liquid crystal display.

In the camera system 1, the ISP 6 may execute at least any of various signal processes that the imaging processing circuit 14 is configured to execute in the present embodiment. In the camera system 1, the imaging processing circuit 14 may execute at least any of processes that the ISP 6 is configured to execute. The image restoring circuit 16 need only be provided in at least one of the ISP 6 and the imaging processing circuit 14. In the camera system 1, both the imaging processing circuit 14 and the ISP 6 may execute at least any of various processes. The imaging processing circuit 14 and the ISP 6 may also execute processes other than the processes described in the present embodiment.

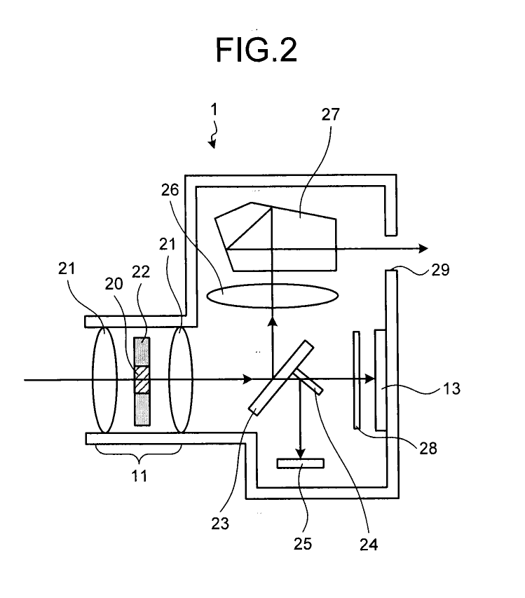

FIG. 2 is a schematic diagram showing the configuration of an optical system incorporated in the camera system shown in FIG. 1. Image pickup lenses 21 form part of the image pickup optical system 11. The lens drive unit 12 moves either of the image pickup lenses 21 along the optical axis direction.

A diaphragm 22 adjusts the amount of light passing through the image pickup optical system 11. Light incident on the image pickup optical system 11 from an object passes through the image pickup optical system 11 and is made incident on a main mirror 23. Light transmitted by the main mirror 23 is incident on a sub-mirror 24. The light transmitted by the sub-mirror 24 and having passed through a mechanical shutter 28 is incident on the image sensor 13.

Light reflected by the sub-mirror 24 travels to an AF sensor 25. The camera system 1 performs focus adjustment using the detection result of the AF sensor 25. Light reflected by the main mirror 23 goes through a lens 26 and a prism 27 to travel to a finder 29. The optical system incorporated in the camera system 1 may be changed as needed, not being limited to what is described in the embodiment.

An attenuating mask 20 that is a light amount adjusting unit is provided in the opening of the diaphragm 22. The attenuating mask 20 attenuates light having entered. The attenuating mask 20 adjusts the light-amount distribution of light having entered the image pickup optical system 11. The attenuating mask 20 has such a transmittance distribution that the amount of transmitted light is non-uniform along two-dimensional directions perpendicular to the optical axis of the image pickup optical system 11. The attenuating mask 20 has, for example, a mask pattern across which transmittance is made randomly different.

The imaging processing circuit 14 detects phase differences or contrast, thereby obtaining such a position of the image pickup lens 21 that the object is in focus. The imaging processing circuit 14 detects phase differences between an image picked up by the image sensor 13 and an image picked up by the AF sensor 25. The imaging processing circuit 14 obtains the focus deviation amount based on the phase differences. Or the imaging processing circuit 14 detects the contrast of an image picked up by the image sensor 13. The imaging processing circuit 14 searches for such a position of the image pickup lens 21 that the contrast is the highest.

The AF driver 15 changes focus continuously during the exposure time of the image sensor 13. The AF driver 15 moves the image pickup lens 21 along the optical axis direction of the image pickup optical system 11, thereby changing focus. At this time, the AF driver 15 moves the image pickup lens 21 between a first position and a second position. The first position is located on the object side of the position of the image pickup lens 21 when in focus. The second position is located on the image sensor 13 side of the position of the image pickup lens 21 when in focus. The camera module 2 picks up an object image with changing focus continuously during the exposure time.

The image restoring circuit 16 performs conversion of pixel values using the spatial filter as the image restoration process. The spatial filter denotes a relation between an image degraded due to a motion blur and an out-of-focus blur and the original image before degraded. A point spread function (PSF) is a function representing the spread of a point image. The image restoring circuit 16 performs, for example, a reverse convolution operation using a preset known PSF in the image restoration process.

An out-of-focus blur occurring when the object is out of focus is superimposed on an image acquired by the solid-state imaging device 5 by changing focus continuously during the exposure time. Further, if an image of an object moving with respect to the camera system 1 during the exposure time is picked up, then a motion blur occurs in the image acquired by the solid-state imaging device 5.

Suppose that, in the situation where stable focus adjustment is difficult, focus adjustment based on the detection of phase differences or contrast is performed. When the focal point determined by the focus adjustment is out of focus, an out-of-focus blur corresponding to being out of focus occurs in the image. The image restoring circuit 16 infers a PSF agreeing with the object distance. The image restoring circuit 16 performs the image restoration process using the inferred PSF.

The motion blur has directivity of the direction in which the object moves with respect to the camera system 1. The PSF for the motion blur is denoted by the spatial filter having coefficients agreeing with the trail of the motion of the object. In restoring an image having a motion blur, the camera system 1 detects the direction in which the object moves and performs processing using the spatial filter agreeing with the direction.

The out-of-focus blur and the motion blur are different in properties. It is difficult for the image restoring circuit 16 to infer a PSF for an image containing an out-of-focus blur and a motion blur. Further, an image may contain a blur component that a PSF cannot completely represent. Since a blur contained in an image cannot be sufficiently represented by a PSF, the image restoring circuit 16 may emphasize the blur component as noise. In this case, even if the sense of resolution is improved, noise is emphasized, resulting in a decrease in the quality of the image.

By intentionally changing focus during the exposure time, an out-of-focus blur according to this change in focus is contained in the image acquired by the solid-state imaging device 5. By changing focus, the shake of the outline of the object image is increased.

The solid-state imaging device 5 lowers the amount of transmitted light by the attenuating mask 20 so as to perform image pickup over the lengthened exposure time even in the environment where illuminance is not low. By lengthening the exposure time, the shake of the outline due to the movement of the object increases. Further, by changing focus during the exposure time, the shake of the outline due to change in focus is superimposed on the object image. Because the shake of the outline due to change in focus increases regardless of direction, the directivity of the motion blur is lessened.

According to the present embodiment, the camera system 1 comprising the attenuating mask 20 makes a motion blur occur in the image. The camera system 1 makes an out-of-focus blur occur in the image by changing focus continuously during the exposure time. The camera system 1 increases the shake of the outline with use of the out-of-focus blur and the motion blur. The camera system 1 forms an image blurred overall. In such an image, both the dependence of the out-of-focus blur on the object distance and the dependence of the motion blur on the motion of the object are lessened. The blurs contained in the image become uniform to some degree regardless of their cause.

The camera system 1 can perform the image restoration process using a known PSF on the image in which both the dependence on the object distance and on the motion of the object are lessened. The camera system 1 can relatively easily obtain an image close to the original object image. The camera system 1 can perform the image restoration process using a preset PSF regardless of the inferred degradation model including both the motion blur and the out-of-focus blur.

The camera system 1 can suppress the emphasizing of noise by performing the reverse convolution operation after reducing the blur component not completely represented by a PSF. The camera system 1 can effectively suppress a motion blur that may occur as a result of lengthening the exposure time. The camera system 1 can effectively suppress an out-of-focus blur that may occur if the image pickup lens 21 of a low F-number is used. Because the exposure time can be lengthened and a lens of a low F-number can be used, the sensitivity of the camera system 1 can be improved.

In this way, the camera system 1 can easily reduce a blur due to a shake of the object and an out-of-focus blur, thus producing the effect that a clear and high-quality image can be acquired.

The image restoring circuit 16 uses, for example, a fixed PSF held beforehand in the reverse convolution operation. Where the distortion (aberration) of the image pickup lenses 21 included in the image pickup optical system 11 is relatively small, even if a fixed PSF is used, the camera system 1 can obtain images having their blurs effectively reduced.

Or the image restoring circuit 16 may use a PSF selected appropriately from a plurality of PSFs held beforehand in the reverse convolution operation. The image restoring circuit 16 may performs the reverse convolution operation using the point spread function selected according to a distance from center of an image. The image restoring circuit 16 may refer image height as the distance. The image restoring circuit 16 may hold a PSF set for each range of the distance and use the PSF selected according to the distance in the reverse convolution operation. Where the distortion of the image pickup lenses 21 included in the image pickup optical system 11 is relatively large, by using the PSF selected according to the distance, the camera system 1 can obtain images having their blurs effectively reduced. The processing using the PSF set for each range of the distance is useful when the camera system 1 is a mobile terminal with a camera.

The image restoring circuit 16 may hold a PSF for one of the quadrants in the two-dimensional coordinate system. The image restoring circuit 16 obtains a PSF for another quadrant using the PSF held. The image restoring circuit 16 may hold a PSF for each pixel block formed of a plurality of pixels (e.g., 7×5 pixels). The image restoring circuit 16 obtains a PSF for each location in a pixel block by appropriately interpolating between PSFs held therein.

### Second Embodiment

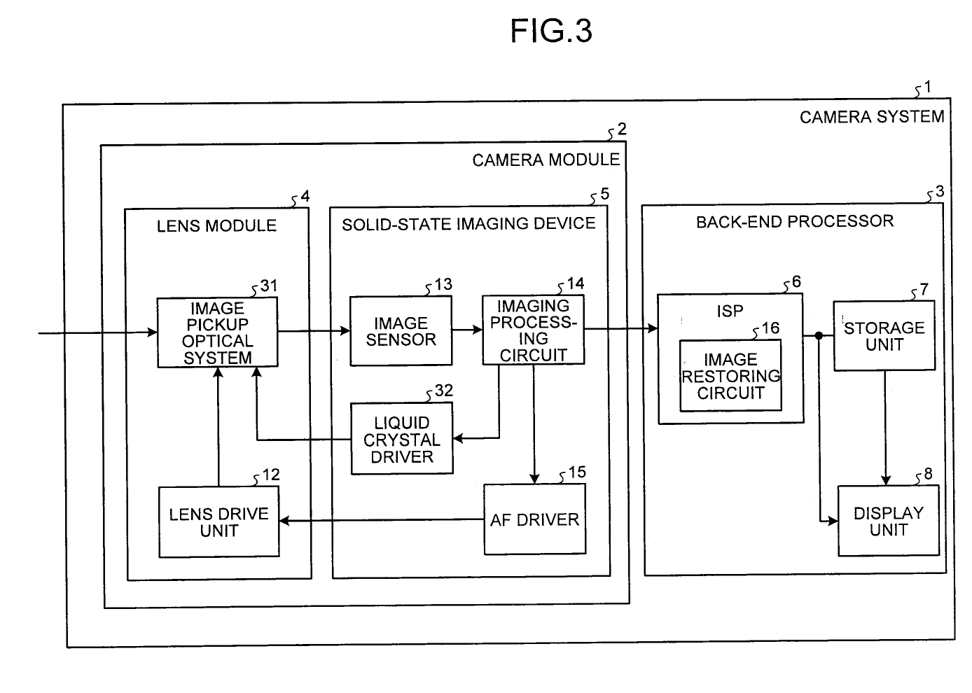

FIG. 3 is a block diagram showing schematically the configuration of a camera system according to the second embodiment. The same reference numerals are used to denote the same parts as in the above first embodiment, with duplicate description thereof being omitted as needed.

The lens module 4 comprises an image pickup optical system 31 and the lens drive unit 12. The solid-state imaging device 5 has the image sensor 13, the imaging processing circuit 14, the autofocus (AF) driver 15, and a liquid crystal driver 32.

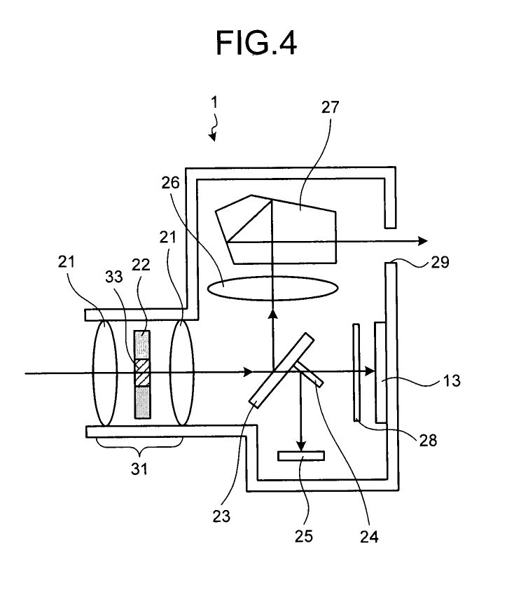

FIG. 4 is a schematic diagram showing the configuration of an optical system incorporated in the camera system shown in FIG. 3. A liquid crystal element 33 that is a light amount adjusting unit is provided in the opening of the diaphragm 22. The liquid crystal element 33 adjusts the amount of transmitted light according to the voltage applied thereto. The liquid crystal element 33 attenuates light having entered, thereby adjusting the light-amount distribution of light passing through the diaphragm 22.

The liquid crystal driver 32 adjusts the voltage applied to the liquid crystal element 33 according to a control signal from the imaging processing circuit 14, thereby controlling the driving of the liquid crystal element 33. While a voltage is being applied thereto by the liquid crystal driver 32, the liquid crystal element 33 blocks portions of the incident light, thereby adjusting the amount of the light. While the application of a voltage is stopped, the liquid crystal element 33 transmits the incident light without blocking.

In the state of blocking portions of the incident light, the liquid crystal element 33 has a transmittance distribution in which the amount of transmitted light is non-uniform along two-dimensional directions perpendicular to the optical axis. The liquid crystal element 33 functions as a mask pattern in which transmittance randomly differs by blocking portions of the incident light. Note that the liquid crystal element 33 may block light when the application of a voltage is stopped and transmit light when a voltage is applied thereto. The liquid crystal driver 32 may control blocking/transmission of light at the liquid crystal element 33 according to, e.g., the image pickup mode of the camera system 1.

The AF driver 15 changes focus continuously during the time of exposure of the image sensor 13 to light having undergone the adjustment of the light-amount distribution at the liquid crystal element 33. The image sensor 13 picks up an object image obtained changing focus continuously. The solid-state imaging device 5 lowers the amount of transmitted light by the liquid crystal element 33 so as to perform image pickup over the lengthened exposure time even in the environment where illuminance is not low.

Also in the present embodiment, the camera system 1 can easily reduce a blur due to a shake of the object and an out-of-focus blur, thus producing the effect that a clear and high-quality image can be acquired. The camera system 1 can switch the image pickup mode between a mode which can reduce a motion blur and an out-of-focus blur and a normal mode by controlling the driving of the liquid crystal element 33.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera system comprising:
an image pickup optical system that takes in light from an object;
a light amount adjusting unit that adjusts a light-amount distribution of light having entered the image pickup optical system;
an image sensor that picks up an object image;
a focus adjusting unit that adjusts focus of the image pickup optical system; and
an image restoring circuit that performs an image restoration process on the image acquired by the image sensor,
wherein the image pickup optical system includes an image pickup lens moving according to control of the focus adjusting unit, and
the focus adjusting unit moves the image pickup lens between a first position and a second position to change focus continuously during the exposure time of the image sensor, the first position being located on the object side of the position of the image pickup lens when in focus, the second position being located on the image sensor side of the position of the image pickup lens when in focus.

2. The camera system according to claim 1, comprising a diaphragm that adjusts the amount of light passing through the image pickup optical system,
wherein the light amount adjusting unit is provided in the diaphragm.

3. The camera system according to claim 2, wherein the light amount adjusting unit comprises a mask that attenuates light having entered, and the mask has such a transmittance distribution that the amount of transmitted light is non-uniform along two-dimensional directions perpendicular to the optical axis of the image pickup optical system.

4. The camera system according to claim 2, wherein the light amount adjusting unit comprises a liquid crystal element that adjusts the amount of transmitted light according to a voltage applied thereto, and the liquid crystal element has such a transmittance distribution that the amount of transmitted light is non-uniform along two-dimensional directions perpendicular to the optical axis of the image pickup optical system.

5. The camera system according to claim 1, wherein the image restoring circuit converts pixel values using a spatial filter in the image restoration process.

6. The camera system according to claim 1, wherein the image restoring circuit performs a reverse convolution operation using a preset point spread function in the image restoration process.

7. The camera system according to claim 6, wherein the image restoring circuit performs the reverse convolution operation using the point spread function selected according to a distance from a center of the image.

8. The camera system according to claim 3, wherein the mask has a mask pattern across which transmittance is made randomly different.

9. An imaging method comprising:
taking in light from an object by an image pickup optical system;
adjusting a light-amount distribution of light having entered the image pickup optical system;
detecting light having undergone adjustment of the light-amount distribution by an image sensor;
picking up an object image with moving an image pickup lens included in the image pickup optical system between a first position and a second position to change focus continuously during the exposure time of the image sensor, the first position being located on the object side of the position of the image pickup lens when in focus, the second position being located on the image sensor side of the position of the image pickup lens when in focus; and
performing an image restoration process on the image acquired by the image sensor.

10. The imaging method according to claim 9, comprising adjusting the amount of light passing through the image pickup optical system by a diaphragm, wherein the light-amount distribution is adjusted at the diaphragm.

11. The imaging method according to claim 10, wherein the light-amount distribution is adjusted at a mask that attenuates light having entered, and
wherein the mask has such a transmittance distribution that the amount of transmitted light is non-uniform along two-dimensional directions perpendicular to the optical axis of the image pickup optical system.

12. The imaging method according to claim 10, wherein the light-amount distribution is adjusted at a liquid crystal element that adjusts the amount of transmitted light according to a voltage applied thereto, and
wherein the liquid crystal element has such a transmittance distribution that the amount of transmitted light is non-uniform along two-dimensional directions perpendicular to the optical axis of the image pickup optical system.

13. The imaging method according to claim 9, wherein in the image restoration process, pixel values are converted using a spatial filter.

14. The imaging method according to claim 9, wherein a reverse convolution operation using a preset point spread function is performed in the image restoration process.

15. The imaging method according to claim 14, wherein the reverse convolution operation using the point spread function selected according to a distance from a center of the image is performed.

16. The imaging method according to claim 11, wherein the mask has a mask pattern across which transmittance is made randomly different.
